(19) United States
(12) Patent Application Publication
(10) Pub. No.: US 2015/0117176 A1
(43) Pub. Date: Apr. 30, 2015

(54) DATA COMMUNICATIONS USING CONNECTIONLESS-ORIENTED PROTOCOL

(71) Applicant: SAMSUNG SDS CO., LTD., Seoul (KR)

(72) Inventors: Joong Bae JEON, Seoul (KR); Hye Jin BAN, Seoul (KR); Min Woo SONG, Seoul (KR)

(73) Assignee: SAMSUNG SDS CO., LTD., Seoul (KR)

(21) Appl. No.: 14/141,844

(22) Filed: Dec. 27, 2013

(30) Foreign Application Priority Data
Oct. 28, 2013 (KR) 10-2013-0128621

(51) Int. Cl. H04L 12/939

(52) U.S. Cl. CPC H04L 49/552
USPC 370/216

(57) ABSTRACT

Provided is a data communication method using a connectionless-oriented protocol. The data communication method includes: configuring indicators, each of the indicators indicating whether a corresponding one of a plurality of data packets is received from a data transmitter; performing a logical operation on the indicators to determine whether there is a lost data packet among the plurality of data packets; and when it is determined that there is the lost data packet, transmitting to the data transmitter an acknowledgment message including the indicators.

### CROSS-REFERENCE TO RELATED APPLICATION

This application claims priority to and the benefit of Korean Patent Application No. 10-2013-0128621, filed on Oct. 28, 2013, the disclosure of which is incorporated herein by reference in its entirety.

### BACKGROUND

1. Field

The present disclosure relates to data communications, and more particularly, to data communications using a connectionless-oriented protocol.

2. Discussion of Related Art

A computer network facilitates communications between many computers. Examples of the computer network include a local area network (LAN), a wide area network (WAN), the Internet, a wireless network, and a hybrid device network.

In such a computer network, data may be transmitted as one or more packets. The original data is reconstructed from the received packets. In some examples, sequence numbers of packets are critical in the data reconstruction.

In a certain network environment (for example, a wireless network environment), due to the occurrence of network interference, the characteristics of a transmission channel, etc., it is highly likely that packets are lost during their transmission. For example, transmission control protocol (TCP) is used for reliable transmission of data in the form of packets between computers over the Internet. TCP is a protocol that can be used in a transport layer. TCP, which is a connection-oriented protocol, allows the establishment and maintenance of a connection while messages are exchanged between computers for data communications by means of applications of the respective computers.

By contrast, user datagram protocol (UDP), which is also available in the transport layer, is a connectionless-oriented protocol. Although UDP allows the transmission of data from a data transmitter to a data receiver so as to provide a communication therebetween, UDP does not involve a procedure for sending a signal indicating that the data is to be transmitted from the data transmitter before the data transmission, nor a procedure for checking a state of the data receiver. UDP itself does not provide a mechanism for the data transmitter to check whether the data is normally received at the data receiver and thus, unlike TCP, cannot ensure transmission reliability.

### SUMMARY

Since UDP does not require a procedure of establishing and releasing a connection for data transmission, UDP is appropriate for use in transmitting data in a more efficient and simpler manner. For example, as compared to TCP, UDP facilitates faster data transmission in a wireless network environment.

A retransmission mechanism may be used for enhanced reliability in a UDP-based data transmission. Examples of the retransmission mechanism include automatic repeat request (ARQ) schemes (for example, Go-Back-N ARQ, Selective-Reject ARQ, and so on). According to an ARQ scheme, the sequence numbers of the packets transmitted from a data transmitter are used for detecting a lost packet, i.e., a packet that is not received at a data receiver after being transmitted from the data transmitter, and in response to the detection of the lost packet, a negative acknowledgment (NACK) is transmitted from the data receiver to the data transmitter.

ARQ schemes may suffer from a loss of a NACK for a packet, i.e., when the NACK is transmitted from the data receiver but not received at the data transmitter. Typically, the packet is not retransmitted until the data transmitter receives the NACK for the packet at a next time or a timeout occurs while, for a certain time interval, the data transmitter has not received an acknowledgment (ACK) indicating that the packet is received. Accordingly, if there occurs a loss of a NACK indicating that a certain packet is not received, it may take a considerable time to retransmit the packet.

Further, according to such ARQ schemes, if there is a loss of an ACK for a packet, i.e., when the ACK is transmitted from the data receiver but not received at the transmitter, a timeout occurs at the data transmitter and then the packet is unnecessarily retransmitted, although the packet has been already received at the data receiver.

Exemplary embodiments employ a retransmission mechanism for data communication based on a connectionless-oriented protocol such as UDP, and provide, instead of a typical ACK/NACK, a novel acknowledgment message including information indicating whether each data packet in a set of data packets is received at a data receiver. By way of example, the above-mentioned information is updated in response to a data packet being received and, accordingly, is regarded as a kind of cumulative information that may indicate whether each data packet in the data packet set is received and remain until all of the data packets in the set are received. This mechanism may prevent delayed or repeated packet retransmissions which would result from conventional ARQ schemes if an ACK/NACK is lost.

According to exemplary embodiments, an acknowledgment message may be transmitted when there occurs a loss of a data packet, and another acknowledgment message may be transmitted when the lost data packet is received after being retransmitted. Therefore, acknowledgment messages can be transmitted less frequently than the transmission of ACK/NACKs in conventional ARQ schemes.

According to exemplary embodiments, an acknowledgment message includes information that is cumulatively compiled to indicate whether each data packet in a data packet set is received until the acknowledgment message is transmitted. Therefore, unlike conventional ARQ schemes, even if an acknowledgment message is lost, it is possible to expedite the performance of certain operations which should have been performed at a data transmitter in response to the acknowledgment message. This is because when another acknowledgment message subsequent to the lost acknowledgment message is received, those operations may be performed based on the information included in the subsequent acknowledgment message.

According to an exemplary embodiment, there is provided a data communication method using a connectionless-oriented protocol, including: performing at least one bitwise operation on flag bits to determine whether there is a lost data packet among a plurality of data packets, each of the flag bits being configured to indicate, in response to at least one of the plurality of data packets being received from a data transmitter, whether a corresponding one of the plurality of data packets is received; and when it is determined that there is the lost data packet, transmitting to the data transmitter an acknowledgment message including the flag bits.

The data communication method may further include: in response to a reception of the lost data packet retransmitted from the data transmitter, transmitting to the data transmitter another acknowledgment message including the flag bits updated according to the reception of the retransmitted lost data packet.

According to an exemplary embodiment, there is provided a data communication method using a connectionless-oriented protocol, including: in response to receiving, from a data receiver, an acknowledgment message including flag bits, performing at least one bitwise operation on the flag bits to identify a lost data packet among a plurality of data packets, each of the flag bits indicating whether a corresponding one of the plurality of data packets is received at the data receiver; and retransmitting the identified lost data packet to the data receiver.

The data communication method of claim 3 may further include: establishing a time period available for the retransmitting; and repeatedly retransmitting the identified lost data packet during the time period.

According to an exemplary embodiment, there is provided a data receiver for performing data communication using a connectionless-oriented protocol, the data receiver including: a packet loss checker configured to perform at least one bitwise operation on flag bits to determine whether there is a lost data packet among a plurality of data packets, each of the flag bits being configured to indicate, in response to at least one of the plurality of data packets being received from a data transmitter, whether a corresponding one of the plurality of data packets is received; and an acknowledgment message transmitter configured to transmit, when it is determined that there is the lost data packet, to the data transmitter, an acknowledgment message including the flag bits.

The acknowledgment message transmitter may be further configured to transmit, in response to a reception of the lost data packet retransmitted from the data transmitter, to the data transmitter, another acknowledgment message including the flag bits updated according to the reception of the retransmitted lost data packet.

According to an exemplary embodiment, there is provided a data transmitter for performing data communication using a connectionless-oriented protocol, the data transmitter including: a retransmission processor configured to perform, in response to receiving, from a data receiver, an acknowledgment message including flag bits, at least one bitwise operation on the flag bits to identify a lost data packet among a plurality of data packets, each of the flag bits indicating whether a corresponding one of the plurality of data packets is received at the data receiver; and a packet transmitter configured to retransmit the identified lost data packet to the data receiver, in a retransmission.

The retransmission processor may be further configured to: establish a time period available for the retransmission; and repeatedly retransmit the identified lost data packet during the time period.

According to an exemplary embodiment, there is provided a data communication method using a connectionless-oriented protocol, including: configuring indicators, each of the indicators indicating whether a corresponding one of a plurality of data packets is received from a data transmitter; performing a logical operation on the indicators to determine whether there is a lost data packet among the plurality of data packets; and when it is determined that there is the lost data packet, transmitting to the data transmitter an acknowledgment message including the indicators.

The logical operation may be performed on each of the indicators independently of any other one of the indicators.

The data communication method may further include: in response to a reception of a retransmitted data packet from the data transmitter after the transmission of the acknowledgment message, transmitting to the data transmitter another acknowledgment message including the indicators updated according to the reception of the retransmitted identified lost data packet.

The logical operation may be performed based on loss information indicating a previously lost data packet among the plurality of data packets and a largest sequence number among sequence numbers of previously received data packets among the plurality of data packets.

The data communication method may further include: identifying, based on the indicators, a number of lost data packets and at least one data packet that is lost among the plurality of data packets.

The data communication method may further include: establishing a time period available for retransmitting the acknowledgment message to the data transmitter.

The connectionless-oriented protocol may include user datagram protocol (UDP).

According to an exemplary embodiment, there is provided a data communication method using a connectionless-oriented protocol, including: receiving, from a data receiver, an acknowledgment message including indicators, each of the indicators indicating whether a corresponding one of a plurality of data packets is received at the data receiver; performing a logical operation on the indicators to identify a lost data packet among the plurality of data packets; and in response to the identification of the lost data packet, establishing a time period available for retransmitting the lost data packet to the data receiver.

The logical operation may be performed on each of the indicators independently of any other one of the indicators.

The data communication method may further include: in response to receiving, from the data receiver, another acknowledgment message including the indicators updated to indicate that the lost data packet is received at the data receiver after being retransmitted, releasing the established time period to prevent an additional retransmission of the lost data packet.

The data communication method may further include: repeatedly retransmitting the lost data packet during the time period.

The connectionless-oriented protocol may include user datagram protocol.

According to an exemplary embodiment, there is provided a computer-readable recording medium storing a computer program for executing any one of the methods.

According to an exemplary embodiment, there is provided a data receiver for performing data communication using a connectionless-oriented protocol, the data receiver including: a packet loss checker configured to configure indicators, and to perform a logical operation on the indicators to determine whether there is a lost data packet among a plurality of data packets, each of the indicators indicating whether a corresponding one of the plurality of data packets is received from a data transmitter; and an acknowledgment message transmitter configured to transmit, when it is determined that there is the lost data packet, to the data transmitter, an acknowledgment message including the indicators in a transmission.

The logical operation may be performed on each of the indicator independently of any other one of the indicators.

The packet loss checker may be further configured to update the indicators according to a reception of a data packet retransmitted from the lost data transmitter after the transmission of the acknowledgment message, and the acknowledgment message transmitter may be further configured to transmit, in response to the reception of the retransmitted data packet, to the data transmitter, another acknowledgment message including the updated indicators.

The logical operation may be based on loss information indicating a previously lost data packet among the plurality of data packets and a largest sequence number among sequence numbers of previously received data packets among the plurality of data packets.

The packet loss checker may be further configured to identify, based on the indicators, a number of lost data packets and at least one lost data packet that is lost among the plurality of data packets.

The acknowledgment message transmitter may be further configured to establish a time period available for retransmitting the acknowledgment message to the data transmitter.

The connectionless-oriented protocol may include user datagram protocol.

According to an exemplary embodiment, there is provided a data transmitter for performing data communication using a connectionless-oriented protocol, the data transmitter including: a packet transmitter configured to transmit a plurality of data packets to a data receiver; and a retransmission processor configured to: receive, from a data receiver, an acknowledgment message including indicators, each of the indicators indicating whether a corresponding one of the plurality of data packets is received at the data receiver; perform a logical operation on the indicators to identify a lost data packet among a plurality of data packets in an identification; and in response to the identification of the lost data packet, establish a time period available for retransmitting the lost data packet to the data receiver.

The logical operation may be performed on each of the indicators independently of any other one of the indicators.

The retransmission processor may be further configured to release, in response to receiving, from the data receiver, another acknowledgment message including the indicators updated to indicate that the lost data packet is received at the data receiver after being retransmitted, the established time period to prevent an additional retransmission of the lost data packet.

The packet transmitter may be further configured to repeatedly retransmit the lost data packet during the time period.

The connectionless-oriented protocol may include user datagram protocol.

### BRIEF DESCRIPTION OF THE DRAWINGS

The above and other objects, features, and advantages of the present disclosure will become more apparent to those familiar with this field from the following detailed description when taken in conjunction with the accompanying drawings, in which:

FIG. 1 shows a system for data communication according to an embodiment of the present disclosure;

FIG. 2 illustrates a structure of a data packet according to an embodiment of the present disclosure;

FIG. 3 shows a structure of information configured to indicate whether each data packet in a set of data packets is received, according to an embodiment of the present disclosure;

FIG. 4 illustrates bit operations for determining whether there is a lost data packet according to an embodiment of the present disclosure; and

FIG. 5 illustrates a procedure of delivering data packets from a data transmitter to a data receiver according to an embodiment of the present disclosure.

### DETAILED DESCRIPTION OF EXEMPLARY EMBODIMENTS

Exemplary embodiments of the present disclosure will be described below in more detail with reference to the accompanying drawings. However, the embodiments are merely examples and are not to be construed as limiting the present disclosure.

Various details already understood by those familiar with this field will be omitted to avoid obscuring the gist of the present disclosure. Terminology described below is defined considering functions in the present disclosure and may vary according to a user's or operator's intention or usual practice. Thus, the meanings of the terminology should be interpreted based on the overall context of the present specification.

The spirit of the present disclosure is determined by the claims, and the following exemplary embodiments are provided only to efficiently describe the spirit of the present disclosure to those familiar with this field.

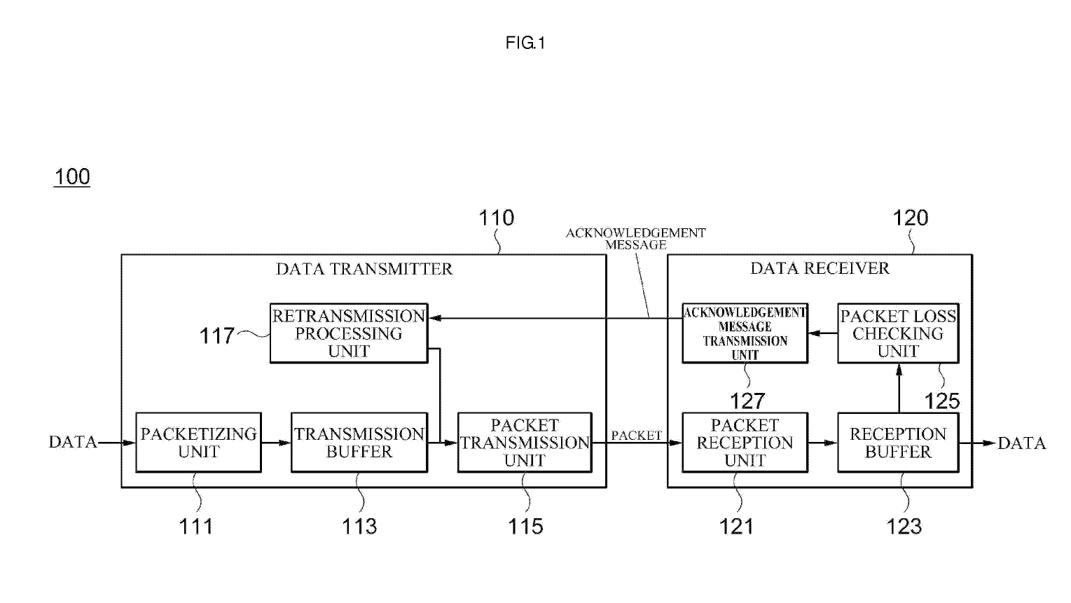

FIG. 1 shows a system for data communication according to an embodiment of the present disclosure.

As shown in FIG. 1, an exemplary data communication system 100 includes a data transmitter 110 and a data receiver 120. The data transmitter 110 is configured to transmit data using a connectionless-oriented protocol, and the data receiver 120 is configured to receive the transmitted data using the connectionless-oriented protocol. The connectionless-oriented protocol used in the data communication system 100 may include UDP.

According to an exemplary embodiment, the data transmitter 110 includes a packetizing unit 111, a transmission buffer 113, a packet transmission unit 115, and a retransmission processing unit 117, and the data receiver 120 includes a packet reception unit 121, a reception buffer 123, a packet loss checking unit 125, and an acknowledgment message transmission unit 127.

The packetizing unit 111 of the data transmitter 110 receives an input of data to be transmitted and converts the data into packets of a certain size. The packetized data is stored in the transmission buffer 113 of the data transmitter 110. The packet transmission unit 115 of the data transmitter 110 transmits the data packets stored in the transmission buffer 113 to the data receiver 120.

The packet reception unit 121 of the data receiver 120 is configured to receive the data packets transmitted from the packet transmission unit 115 of the data transmitter 110. The received data packets are stored in the reception buffer 123 of the data receiver 120. The original transmitted data is reconstructed from the data packets stored in the reception buffer 123.

In an exemplary embodiment, the data packet includes a header and a data payload. For example, the packetizing unit 111 of the data transmitter 110 generates a data packet by adding the header to the data payload which is a portion of the data to be transmitted. When the data packet is received by the data receiver 120, information included in the header of the received data packet may be used for the data receiver 120 to manage the data packet. For example, the header of the data packet may include a sequence number which is given to the data packet.

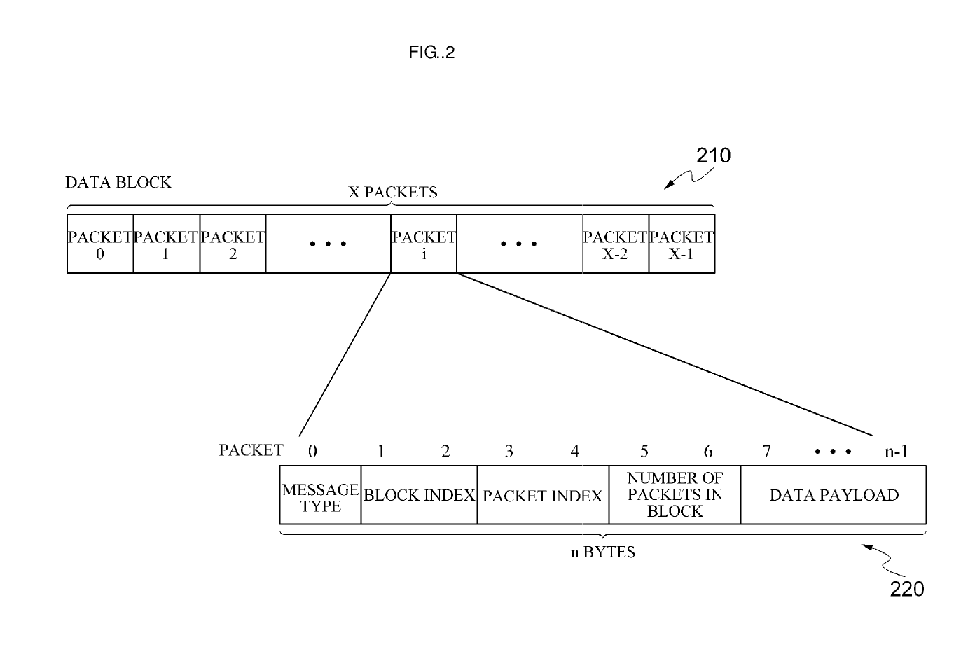

An exemplary structure of a data packet transmitted from the data transmitter 110 will be described below in more detail with reference to FIG. 2. As shown in FIG. 2, an exemplary data packet 220 includes a data payload of n-7 bytes and a header of 7 bytes followed by the data payload. The length n of the data packet 220 is variable. Information indicated by the 7-byte header of the data packet 220 allows data packets stored in the reception buffer 123 to be managed as a block 210 of X data packets shown in FIG. 2. The number X of packets included in the data block 210 is variable.

In the header of the data packet 220, the first byte (byte 0) indicates a message type of the data packet 220, the next two bytes (byte 1 and byte 2) indicate an index of the data block 210 including the data packet 220, the next two bytes (byte 3 and byte 4) indicate an index (for example, i) of the data packet 220 in the data block 210, and the next two bytes (byte 5 and byte 6) indicate the number (for example, X) of data packets included in the data block 210. Accordingly, when the packet reception unit 121 of the data receiver 120 receives the data packet 220, it can be derived, from the header of the data packet 220, at which position in the reception buffer 123 the data packet 220 is to be stored.

A process for retransmitting a lost data packet among the transmitted data packets will be described below with reference to FIG. 1 again.

The packet loss checking unit 125 of the data receiver 120 constructs and manages information (hereinafter, referred to as “packet reception information”) indicating whether each data packet in a set of a certain number of data packets stored in the reception buffer 123 is received from the data transmitter 110. For example, such information may include indicators, each of which may indicate whether a corresponding one of a plurality of data packets in the data packet set has been received from the data transmitter 110. Each indicator may be a single flag or bit within the information. Whenever a data packet is received by the data receiver 120, the packet reception information may be updated to indicate that the data packet is received by the data receiver 120.

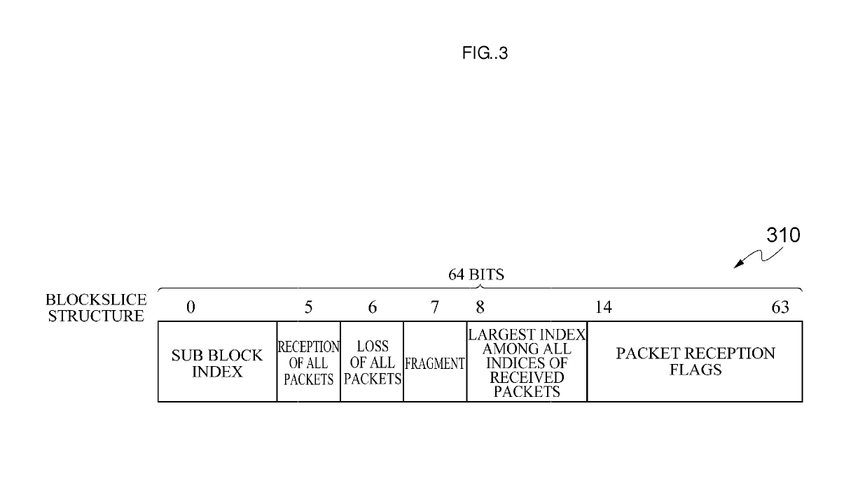

FIG. 3 shows a structure of information configured to indicate whether each data packet in a set of data packets is received, according to an embodiment of the present disclosure. In an exemplary embodiment, the packet loss checking unit 125 maintains a 64-bit BlockSlice structure 310 of FIG. 3 to indicate whether each data packet included in a certain sub-block of the data block 210 shown in FIG. 2 is received. In the BlockSlice structure 310, 50 bits ranging from bit 14 to bit 63 are flags that respectively indicate whether the data packets included in the sub-block are received. Whenever a data packet included in the sub-block is received, the packet loss checking unit 125 sets to 1 a flag bit corresponding to the data packet. That is, a single BlockSlice structure includes information indicating whether each data packet in a set of 50 data packets is received by the data receiver 120.

In the block slice structure 310, 5 bits ranging from bit 0 to bit 4 indicate an index of the sub-block of the data block 210. For example, when the 5-bit sub-block index is 0, the packet reception flags of 50 bits indicate whether 50 data packets ranging from packet 0 to packet 49 of the data block 210 are received. When the 5-bit sub-block index is 1, the packet reception flags indicate whether 50 data packets ranging from packet 50 to packet 99 of the data block 210 are received.

In the BlockSlice structure 310, bit 5 is set to 1 if all packets are received and to 0 otherwise, and bit 6 is set to 1 if all packets are lost and to 0 otherwise. Bit 7 is a fragment bit that is set to 1 if the sub-block is being received and to 0 otherwise, and 6 bits ranging from bit 8 to bit 13 indicate the largest index among the indices of the received data packets in the sub-block (e.g. the packet index of the data packet 220). Whenever a data packet is received, the 6 bits indicating the largest index of the indices of the already-received packets may be compared with the index of the received data packet and may be updated in accordance with a result of the comparison.

Referring to FIG. 1 again, it will be further described how the packet loss checking unit 125 operates.

The packet loss checking unit 125 determines whether there is a lost data packet among the plurality of data packets in the data packet set, based on the information including the indicators indicating whether a corresponding one of the data packets is received. In addition, based on loss information indicating one or more previously lost data packets among the plurality of data packets and further based on the largest one of the sequence numbers of the previously received data packets among the sequence numbers of the plurality of data packets (for example, the largest index indicated in the BlockSlice structure 310), it may be determined whether there exists a lost data packet. Moreover, based on the above-described packet reception information, the packet loss checking unit 125 may identify how many data packets are lost and/or which data packet is lost among the data packets in the data packet set.

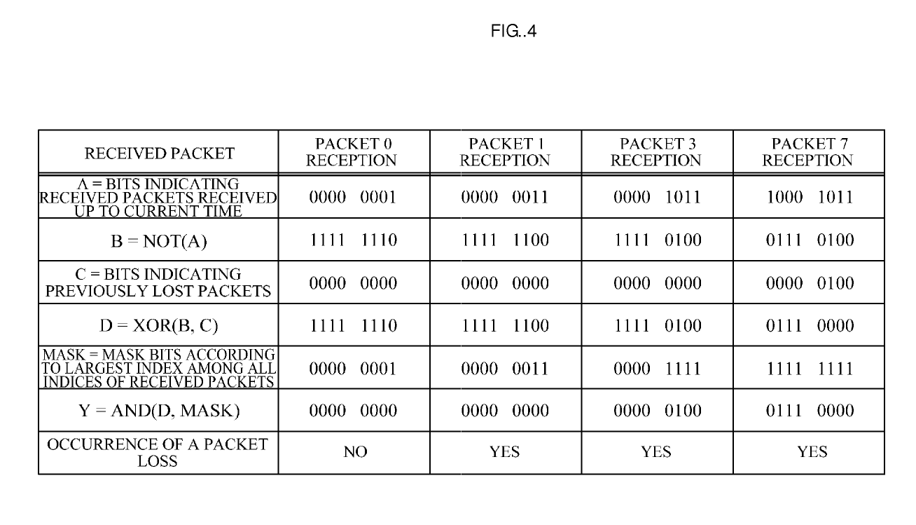

The operation of the packet loss checking unit 125 for determining whether there exists a lost data packet among the data packets in the data packet set may include an operation of performing a logical operation on the indicators within the packet reception information. For example, the packet loss checking unit 125 may determine whether there is a lost packet using the bit operations shown in FIG. 4. FIG. 4 shows an exemplary process of determining whether there is a lost packet when packet 0, packet 1, packet 3, and packet 7 are, in turn, received by the data receiver 120. For the sake of convenience, FIG. 4 shows bit operations on 8 bits. It will be understood that the number of bits, which are operands of the bit operations illustrated in a disclosed embodiment, is not limited thereto.

Furthermore, the above-mentioned logical operation may be performed in a manner in which each of the indicators in the packet reception information is treated irrespectively of the other indicators. In a certain embodiment, the logical operation may be a bitwise operation (for example, a bitwise NOT operation, a bitwise AND operation, a bitwise XOR operation, a bitwise OR operation, and so on).

The logical operation may include at least one unary operation where the indicators are taken as a single operand. Additionally or alternatively, the logical operation may include at least one dyadic operation which takes, as its operands, the indicators along with the loss information indicating one of the plurality of data packets, which is lost before the determination as to whether there is a lost data packet among the data packets in the data packet set, or with the information indicating the largest sequence number among the sequence numbers of the received data packets in the data packet set. For example, the bit operations shown in FIG. 4 include a bitwise NOT operation on the bits (hereinafter, collectively referred to as “A”) indicating the packets received up to the current time point, a bitwise XOR operation on the resulting bits (hereinafter, collectively referred to as “B”) of the NOT operation and the bits (hereinafter, collectively referred to as “C”) indicating the previously lost packets, and a bitwise AND operation on the mask bits (hereinafter, collectively referred to as “MASK”) determined according to the largest index among the indices of the received packets (for example, the largest index indicated in the BlockSlice structure 310) and the resulting bits (hereinafter, collectively referred to as “D”) of the XOR operation. When the resulting bits (hereinafter, collectively referred to as “Y”) of the AND operation indicate greater than 0, it is determined that there is a lost packet. Such bit operations may allow the time complexity required for determining whether there occurs a packet loss to be lowered to the level of 0(1).

With reference to FIG. 4, an exemplary process of determining whether there occurs a packet loss will be described. In an example illustrated in FIG. 4, the respective bits of “A,” “B,” “C,” “D,” “Y,” and “MASK” correspond to packet 0 to packet 8 from right to left. When packet 1 is received, A is 00000011 since the received data packets are packet 0 and packet 1 and C is 00000000 since no data packet is yet lost. Thus, D is 11111100. MASK is set to 00000011 according to the largest index (i.e., 1) among the indices (i.e., 0 and 1) of the received data packets. (Among the bits of MASK, each of the bits corresponding to the packets ranging from packet 0 to the packet of the largest index is set to 1). As a result, Y is 00000000 and, therefore, it is determined that there is no data packet loss. Then, when packet 3 is received, A is 00001011 since the received data packets are packet 0, packet 1, and packet 3 and C is 00000000 since no data packet is yet lost. Thus, D is 11110100. MASK is 00001111 since the largest index among the indices of the received data packets is 3. As a result, Y is 00000100 and, therefore, it is determined that there occurs a data packet loss. Subsequently, the packet loss checking unit 125 may use Hamming Weight algorithm and Find First Bit algorithm to identify how many data packets are lost and which data packets are lost.

Referring to FIG. 1 again, an operation of retransmitting lost packets will be discussed.

The acknowledgment message transmission unit 127 of the data receiver 120 transmits a certain acknowledgment message to the data transmitter 110 when it is determined that there is a lost data packet. The acknowledgment message includes the packet reception information that is constructed and updated by the packet loss checking unit 125. For example, in response to the determination that there is a data packet loss, the acknowledgment message transmission unit 127 transmits, to the data transmitter 110, an acknowledgment message including the 64-bit BlockSlice structure 310, where the fragment bit of the BlockSlice structure 310 is set to 1. Additionally, when the acknowledgment message including the BlockSlice structure 310 is lost, the acknowledgment message transmission unit 127 may establish a time period for retransmitting the acknowledgment message. When all of the data packets indicated by the BlockSlice structure 310 are received by the data receiver 120, the established time period may be released. For example, the time period establishment and the time period release may involve driving and removing a timer, respectively. When bit 6 of the BlockSlice structure 310 is set to 1 (i.e., when all of the data packets of the sub-block corresponding to the BlockSlice structure 310 are lost), the acknowledgment message transmission unit 127 may transmit an acknowledgment message including 8 bits ranging from bit 0 to bit 7, instead of all bits (64 bits), of the BlockSlice structure 310.

The retransmission processing unit 117 of the data transmitter 110 is configured to receive an acknowledgment message. In addition, the retransmission processing unit 117 may identify a newly lost data packet among the data packets in the data packet set based on the packet reception information included in the received acknowledgment message. For example, when the retransmission processing unit 117 receives an acknowledgment message including the BlockSlice structure 310 with the fragment bit set to 1, the retransmission processing unit 117 may identify, based on the BlockSlice structure 310, which of the data packets is the lost data packet. Such identification may be performed in the same manner as the packet loss checking unit 125 identifies a lost data packet (for example, by using the bit operations described above with reference to FIG. 4).

When the retransmission processing unit 117 identifies a lost data packet, the identified data packet is retransmitted through the packet transmission unit 115. In addition, the retransmission processing unit 117 establishes a time period available for retransmitting the lost data packet in response to the identification of the lost data packet. For example, the establishment of the time period may involve driving a timer for the retransmission. In an exemplary embodiment, the retransmission timer may be set for the data packet that is identified to be lost, instead of being set for all data packets. The lost data packet may be repeatedly retransmitted from the packet transmission unit 115 during the established time period. For example, the lost data packet may be periodically retransmitted from the packet transmission unit 115, and such retransmission period may be obtained by adding a round trip time of the data communication system 100 to a certain value (which may be set according to characteristics of the data communication system 100 and/or a transmission environment of a data packet).

Subsequently, when a data packet retransmitted through the packet transmission unit 115 of the data transmitter 110 is received at the packet reception unit 121 of the data receiver 120, the packet loss checking unit 125 updates the packet reception information according to the reception of the retransmitted data packet, and the acknowledgment message transmission unit 127 transmits to the data transmitter 110 the acknowledgment message including the updated packet reception information. For example, the acknowledgment message, which is transmitted from the acknowledgment message transmission unit 127 in response to the reception of the retransmitted data packet, may include the BlockSlice structure 310 with the fragment bit set to 0. The type of this acknowledgment message is different from that of the acknowledgment message transmitted in response to the determination that there is a lost data packet, and these two types of acknowledgment messages are distinguished from each other by the fragment bits of the BlockSlice structures 310 included therein.

Additionally, still another type of acknowledgment message may be transmitted from the acknowledgment message transmission unit 127 to the data transmitter 110. If all of the data packets of the sub-block covered by the BlockSlice structure 310 are received, the acknowledgment message including the 64-bit BlockSlice structure 310 with the bit representing the reception of all of the data packets (bit 5 of the BlockSlice structure 310) set to 1 may be transmitted to the data transmitter 110. Alternatively, the acknowledgment message including 8 bits ranging from for bit 0 to bit 7, instead of 64 bits in the BlockSlice structure 310, may be transmitted to the data transmitter 110. The acknowledgment message is transmitted to prevent unnecessary data packet retransmission.

When the retransmission processing unit 117 of the data transmitter 110 receives an acknowledgment message transmitted in response to the reception of a retransmitted data packet (for example, when the retransmission processing unit 117 receives an acknowledgment message including the BlockSlice structure 310 with the fragment bit set to 0), the retransmission processing unit 117 releases the established time period for retransmitting the data packet, thereby preventing the data packet, which is previously lost but is retransmitted and then received at the data receiver 120, from being unnecessarily and repeatedly retransmitted. In an embodiment in which the establishment of the time period involves driving a timer, the release of the established time period involves removing the timer.

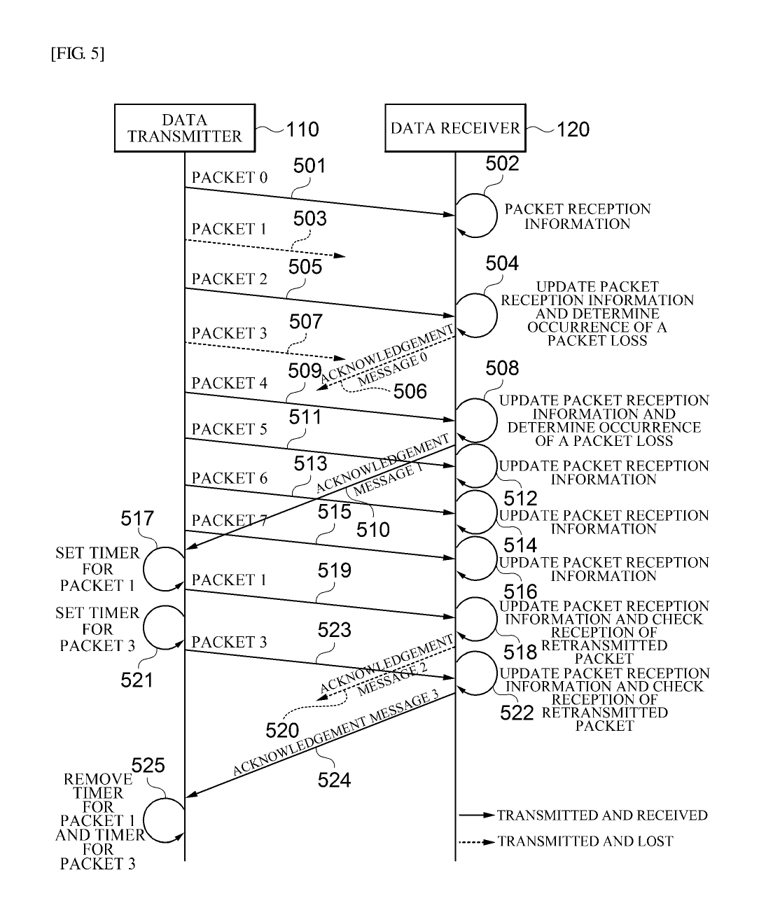

FIG. 5 illustrates a procedure of delivering data packets from a data transmitter to a data receiver according to an embodiment of the present embodiment. In operation 501, the data transmitter 110 transmits packet 0. In operation 502, the data receiver 120 receives packet 0 and updates packet reception information according to the reception of packet 0.

In operation 503, the data transmitter 110 transmits packet 1. However, in an example shown in FIG. 5, packet 1 is not received at the data receiver 120 and is lost.

In operation 505, the data transmitter 110 transmits packet 2. In operation 504, the data receiver 120 receives packet 2, updates the packet reception information according to the reception of packet 2, and determines that there is a packet loss. Further, the data receiver 120 may identify packet 1 as being lost. For example, such determination and identification may use the bit operations illustrated in association with FIG. 4. In operation 506, in response to the determination that there is a lost packet, the data receiver 120 transmits to the data transmitter 110 acknowledgment message 0 including the updated packet reception information. The updated packet reception information indicates that packet 0 and packet 2 are received at the data receiver 120 and that packet 1 is not received at the data receiver 120. However, in an example shown in FIG. 5, acknowledgment message 0 is not received at the data transmitter 110 and is lost.

In operation 507, the data transmitter 110 transmits packet 3. However, in an example of FIG. 5, packet 3 is not received at the data receiver 120 and is lost.

In operation 509, the data transmitter 110 transmits packet 4. In operation 508, the data receiver 120 receives packet 4, updates the packet reception information according to the reception of packet 4, and determines that there is a packet loss based on the packet reception information. Further, the data receiver 120 may identify packet 3 as being lost. In operation 510, in response to the determination that there is a lost packet, the data receiver 120 transmits to the data transmitter 110 acknowledgment message 1 including the updated packet reception information. The updated packet reception information indicates that packet 0, packet 2, and packet 4 are received at the data receiver 120 and that packet 1 and packet 3 are not received at the data receiver 120.

The data transmitter 110 performs transmission 511 of packet 5, transmission 513 of packet 6, and transmission 515 of packet 7. In operations 512, 514, and 516, the data receiver 120 updates the packet reception information in succession when receiving packet 5, packet 6, and packet 7.

When the data transmitter 110 receives acknowledgment message 1, the data transmitter 110 establishes a timer for retransmission of packet 1, which is identified, from acknowledgment message 1, as a lost packet (operation 517), and retransmits packet 1 (operation 519). In addition, the data transmitter 110 establishes a timer for retransmission of packet 3 identified, from acknowledgment message 1, as a lost packet (operation 521), and retransmits packet 3 (operation 523).

In operation 518, the data receiver 120 receives retransmitted packet 1, updates the packet reception information according to the reception of packet 1, and checks that the retransmitted packet is received. Then, in operation 520, the data receiver 120 transmits to the data transmitter 110 acknowledgment message 2 including the updated packet reception information. The updated packet reception information indicates that packet 0 to packet 2 and packet 4 to packet 7 are received at the data receiver 120 and that packet 3 is not received at the data receiver 120. However, in an example shown in FIG. 5, acknowledgment message 2 is not transmitted to the data transmitter 110 and is lost.

In operation 522, the data receiver 120 receives retransmitted packet 3, updates the packet reception information according to the reception of packet 3, and checks that the retransmitted packet is received. Then, in operation 524, the data receiver 120 transmits to the data transmitter 110 acknowledgment message 3 including the updated packet reception information. The updated packet reception information indicates that packets 0 to 7 are received at the data receiver 120.

When the data transmitter 110 receives acknowledgment message 3, the data transmitter 110 checks, based on the packet reception information included in acknowledgment message 3, that packet 1 and packet 3, for which the timers are previously established, are received at the data receiver 120, and removes the timer for packet 1 and the timer for packet 3.

Embodiments of the present disclosure may prevent delayed or repeated packet retransmissions which would result from conventional ARQ schemes if an ACK/NACK is lost.

According to embodiments of the present disclosure, the expected value of the number of transmitted acknowledgment messages is less than that of the number of ACK/NACKs transmitted in accordance with conventional ARQ schemes.

According to embodiments of the present disclosure, even if an acknowledgment message is lost, it is possible to expedite the performance of certain operations which should have been performed in response to the acknowledgment message.

Meanwhile, exemplary embodiments of the present disclosure may include a computer-readable recording medium including a program for performing the methods described in the present specification in a computer. The computer-readable recording medium may include program instructions, local data files, and local data structures, alone or in combination. The medium may be specially designed and configured for the present disclosure, or well known and available to those skilled in the field of computer software. Examples of the computer-readable recording medium include magnetic media such as a hard disk, a floppy disk and a magnetic tape, optical recording media such as a CD-ROM and a DVD, a magneto-optical medium such as a floptical disk, and hardware devices, specially configured to store and execute program instructions, such as a ROM, a RAM, and a flash memory. Examples of the program instructions may include high-level language codes executable by a computer using an interpreter or the like, as well as machine language codes made by a compiler.

It will be apparent to those familiar with this field that various modifications can be made to the above-described exemplary embodiments of the present disclosure without departing from the spirit or scope of the disclosure.

Thus, it is intended that the present disclosure covers all such modifications provided they come within the scope of the appended claims and their equivalents.

What is claimed is:

1. A data communication method using a connectionless-oriented protocol, comprising:
performing at least one bitwise operation on flag bits to determine whether there is a lost data packet among a plurality of data packets, each of the flag bits being configured to indicate, in response to at least one of the plurality of data packets being received from a data transmitter, whether a corresponding one of the plurality of data packets is received; and
when it is determined that there is the lost data packet, transmitting to the data transmitter an acknowledgment message comprising the flag bits.

2. The data communication method of claim 1, further comprising: in response to a reception of the lost data packet retransmitted from the data transmitter, transmitting to the data transmitter another acknowledgment message comprising the flag bits updated according to the reception of the retransmitted lost data packet.

3. A data communication method using a connectionless-oriented protocol, comprising:
in response to receiving, from a data receiver, an acknowledgment message comprising flag bits, performing at least one bitwise operation on the flag bits to identify a lost data packet among a plurality of data packets, each of the flag bits indicating whether a corresponding one of the plurality of data packets is received at the data receiver; and
retransmitting the identified lost data packet to the data receiver.

4. The data communication method of claim 3, further comprising:
establishing a time period available for the retransmitting; and
repeatedly retransmitting the identified lost data packet during the time period.

5. A data receiver for performing data communication using a connectionless-oriented protocol, the data receiver comprising:
a packet loss checker configured to perform at least one bitwise operation on flag bits to determine whether there is a lost data packet among a plurality of data packets, each of the flag bits being configured to indicate, in response to at least one of the plurality of data packets being received from a data transmitter, whether a corresponding one of the plurality of data packets is received; and
an acknowledgment message transmitter configured to transmit, when it is determined that there is the lost data packet, to the data transmitter, an acknowledgment message comprising the flag bits.

6. The data receiver of claim 5, wherein the acknowledgment message transmitter is further configured to transmit, in response to a reception of the lost data packet retransmitted from the data transmitter, to the data transmitter, another acknowledgment message comprising the flag bits updated according to the reception of the retransmitted lost data packet.

7. A data transmitter for performing data communication using a connectionless-oriented protocol, the data transmitter comprising:
a retransmission processor configured to perform, in response to receiving, from a data receiver, an acknowledgment message comprising flag bits, at least one bitwise operation on the flag bits to identify a lost data packet among a plurality of data packets, each of the flag bits indicating whether a corresponding one of the plurality of data packets is received at the data receiver; and
a packet transmitter configured to retransmit the identified lost data packet to the data receiver, in a retransmission.

8. The data transmitter of claim 7, wherein the retransmission processor is further configured to:
establish a time period available for the retransmission; and
repeatedly retransmit the identified lost data packet during the time period.

9. A data communication method using a connectionless-oriented protocol, comprising:
configuring indicators, each of the indicators indicating whether a corresponding one of a plurality of data packets is received from a data transmitter;
performing a logical operation on the indicators to determine whether there is a lost data packet among the plurality of data packets; and
when it is determined that there is the lost data packet, transmitting to the data transmitter an acknowledgment message comprising the indicators.

10. The data communication method of claim 9, wherein the logical operation is performed on each of the indicators independently of any other one of the indicators.

11. The data communication method of claim 9, further comprising: in response to a reception of a retransmitted data packet from the data transmitter after the transmission of the acknowledgment message, transmitting to the data transmitter another acknowledgment message comprising the indicators updated according to the reception of the retransmitted identified lost data packet.

12. The data communication method of claim 9, wherein the logical operation is performed based on loss information indicating a previously lost data packet among the plurality of data packets and a largest sequence number among sequence numbers of previously received data packets among the plurality of data packets.

13. The data communication method of claim 9, further comprising: identifying, based on the indicators, a number of lost data packets and at least one data packet that is lost among the plurality of data packets.

14. The data communication method of claim 9, further comprising: establishing a time period available for retransmitting the acknowledgment message to the data transmitter.

15. The data communication method of claim 9, wherein the connectionless-oriented protocol comprises user datagram protocol (UDP).

16. A data communication method using a connectionless-oriented protocol, comprising:
receiving, from a data receiver, an acknowledgment message comprising indicators, each of the indicators indicating whether a corresponding one of a plurality of data packets is received at the data receiver;
performing a logical operation on the indicators to identify a lost data packet among the plurality of data packets; and
in response to the identification of the lost data packet, establishing a time period available for retransmitting the lost data packet to the data receiver.

17. The data communication method of claim 16, wherein the logical operation is performed on each of the indicators independently of any other one of the indicators.

18. The data communication method of claim 16, further comprising: in response to receiving, from the data receiver, another acknowledgment message comprising the indicators updated to indicate that the lost data packet is received at the data receiver after being retransmitted, releasing the established time period to prevent an additional retransmission of the lost data packet.

19. The data communication method of claim 16, further comprising:
repeatedly retransmitting the lost data packet during the time period.

20. The data communication method of claim 16, wherein the connectionless-oriented protocol comprises user datagram protocol.

21. A computer-readable recording medium storing a computer program for executing the method of claim 1.

22. A data receiver for performing data communication using a connectionless-oriented protocol, the data receiver comprising:
a packet loss checker configured to configure indicators, and to perform a logical operation on the indicators to determine whether there is a lost data packet among a plurality of data packets, each of the indicators indicating whether a corresponding one of the plurality of data packets is received from a data transmitter; and
an acknowledgment message transmitter configured to transmit, when it is determined that there is the lost data packet, to the data transmitter, an acknowledgment message comprising the indicators in a transmission.

23. The data receiver of claim 22, wherein the logical operation is performed on each of the indicators independently of any other one of the indicators.

24. The data receiver of claim 22, wherein the packet loss checker is further configured to update the indicators according to a reception of a lost data packet retransmitted from the data transmitter after the transmission of the acknowledgment message, and
the acknowledgment message transmitter is further configured to transmit, in response to the reception of the retransmitted data packet, to the data transmitter, another acknowledgment message comprising the updated indicators.

25. The data receiver of claim 22, wherein the logical operation is based on loss information indicating a previously lost data packet among the plurality of data packets and a largest sequence number among sequence numbers of previously received data packets among the plurality of data packets.

26. The data receiver of claim 22, wherein the packet loss checker is further configured to identify, based on the indicators, a number of lost data packets and at least one lost data packet that is lost among the plurality of data packets.

27. The data receiver of claim 22, wherein the acknowledgment message transmitter is further configured to establish a time period available for retransmitting the acknowledgment message to the data transmitter.

28. The data receiver of claim 22, wherein the connectionless-oriented protocol comprises user datagram protocol.

29. A data transmitter for performing data communication using a connectionless-oriented protocol, the data transmitter comprising:
a packet transmitter configured to transmit a plurality of data packets to a data receiver; and
a retransmission processor configured to: receive, from a data receiver, an acknowledgment message comprising indicators, each of the indicators indicating whether a corresponding one of the plurality of data packets is received at the data receiver; perform a logical operation on the indicators to identify a lost data packet among a plurality of data packets in an identification; and in response to the identification of the lost data packet, establish a time period available for retransmitting the lost data packet to the data receiver.

30. The data transmitter of claim 29, wherein the logical operation is performed on each of the indicators independently of any other one of the indicators.

31. The data transmitter of claim 29, wherein the retransmission processor is further configured to release, in response to receiving, from the data receiver, another acknowledgment message comprising the indicators updated to indicate that the lost data packet is received at the data receiver after being retransmitted, the established time period to prevent an additional retransmission of the lost data packet.

32. The data transmitter of claim 29, wherein the packet transmitter is further configured to repeatedly retransmit the lost data packet during the time period.

33. The data transmitter of claim 29, wherein the connectionless-oriented protocol comprises user datagram protocol.
